(19) United States
(12) Patent Application Publication
(10) Pub. No.: US 2026/0039718 A1
(43) Pub. Date: Feb. 5, 2026

(54) SYSTEM AND METHOD FOR PROCESSING SENSOR DATA AT AN EDGE DEVICE

(71) Applicant: Booz Allen Hamilton Inc., McLean, VA (US)

(72) Inventors: Marc F. DiNino, Andover, MA (US); Sonya Rahmani, McLean, VA (US); Vijay Jadav, Tampa, FL (US); Bradley Royal, Orlando, FL (US)

(73) Assignee: Booz Allen Hamilton Inc., McLean, VA (US)

(21) Appl. No.: 19/286,173

(22) Filed: Jul. 30, 2025

Related U.S. Application Data
(60) Provisional application No. 63/677,656, filed on Jul. 31, 2024.

(51) Int. Cl. H04L 67/125

(52) U.S. Cl. CPC H04L 67/125

(57) ABSTRACT

Exemplary system and methods for processing sensor data at the edge. The edge device being encoded with programming code for executing at least one application module to discover one or more sensors. The processor connects the one or more discovered sensors to one of plural client interfaces for receiving sensor data. The sensor data received from each sensor is converted from a vendor specific format to a standardized format. The standardized sensor data is communicated to a remote edge device at a predetermined transmission interval.

### FIELD

The subject matter disclosed relates generally to processing sensor data, and more particularly to system and methods that perform hardware agnostic sensor data processing at an edge device.

### BACKGROUND

Tactical, emergency, and military units are frequently deployed in environments where the safety and security of every team member is essential to ensuring a successful mission or outcome. On-body and/or environmental sensor technology is currently used to track the status and/or locations of team members. While many types of sensors are readily available in the current market landscape, contextualizing their data presents a challenge for users. Current solutions for data ingestion, fusion, and processing are all being developed independently and from the ground up. As a result, user adaptation is both slow and vendor dependent. This is a challenge across several spaces including military spaces for training and operations. Military personnel desire to use commercially available sensors to simplify daily operations. However, these commercial sensors may raise a security concern for operations being conducted as the biometric, environmental location, and/or health data is commonly sent to the cloud for storage.

### SUMMARY

An exemplary edge device, is disclosed comprising: memory configured for storing programming code for executing at least one application module for processing sensor data; a processor configured to execute the programming code, the programming code causing the processor to generate the at least one application module and be further configured to: discover, by one or more communication interfaces, one or more sensors; connect the one or more discovered sensors to one of plural client interfaces for receiving sensor data; convert the received sensor data of each sensor to a standardized format, wherein at least two of the sensors have different client interfaces; and communicate the standardized sensor data to a remote edge device at a predetermined transmission interval.

An exemplary method for processing sensor data at an edge device is disclosed, the method comprising: storing, by a memory device, programming code for executing at least one application module for processing sensor data; executing, by the edge device, the programming code stored in the memory device, the programming code causing the edge device to be configured to perform operations including: discovering, by one or more communication interfaces of the edge device, one or more sensors within a predetermined range; connecting, by a processor of the edge device, the one or more discovered sensors to one of plural client interfaces for receiving sensor data; converting, by the processor, the received sensor data of each sensor to a standardized format, wherein at least two of the sensors have different client interfaces; and communicating, by the processor, the standardized sensor data to a remote edge device at a predetermined transmission interval.

A non-transitory computer readable medium encoded with program code for processing sensor data is disclosed, the computer readable medium, when placed in communicable contact with a device processor, causes the device processor to be configured to: discover, by one or more communication interfaces, one or more sensors; connect the one or more discovered sensors to one of plural client interfaces for receiving sensor data; convert the received sensor data of each sensor to a standardized format, wherein at least two of the sensors have different client interfaces; and communicate the standardized sensor data to a remote edge device at a predetermined transmission interval.

### DESCRIPTION OF THE DRAWINGS

Exemplary embodiments are best understood from the following detailed description when read in conjunction with the accompanying drawings. Included in the drawings are the following figures:

FIG. 1 illustrates a system for processing sensor data in accordance with an exemplary embodiment of the present disclosure.

FIG. 2 illustrates a sensor integration application in accordance with an exemplary embodiment of the present disclosure.

FIG. 3 illustrates a state machine performed by the sensor integration application in accordance with an exemplary embodiment of the present disclosure.

FIG. 4 illustrates a block diagram of a host application with the integrated sensor integration application in accordance with an exemplary embodiment of the present disclosure.

FIG. 5 illustrates a data flow for throttling notification messages in accordance with an exemplary embodiment of the present disclosure.

FIG. 6 illustrates data flow in an edge device of FIG. 1 in accordance with an exemplary embodiment of the present disclosure.

FIG. 7 illustrates a method for processing sensor data in accordance with an exemplary embodiment of the present disclosure.

FIG. 8 illustrates a hardware configuration of an edge device in accordance with an exemplary embodiment of the present disclosure.

Further areas of applicability of the present disclosure will become apparent from the detailed description provided hereinafter. It should be understood that the detailed descriptions of exemplary embodiments are intended for illustration purposes only and, therefore, are not intended to necessarily limit the scope of the disclosure.

### DETAILED DESCRIPTION

Systems and methods disclosed herein provide a hardware-agnostic device for processing sensor data from one or more on-body or environmental sensors regardless of the provider or vendor. The system can discover and pair the one or more sensors to an edge device and collect data and metric information from each sensor using a vendor-specific client process. The sensor data can be aggregated and translated from a vendor specific data format to a standardized format. The aggregated sensor data is shared between edge devices on a network without a server, cloud device or centralized data management or processing system.

According to an exemplary embodiment, systems and method of the present disclosure can reduce the cognitive load for users by leveraging machine learning (ML) technology to interpret sensor data and simplify tasks. ML models can be used to generate important notifications about the wearer and their surroundings. These notifications, which may encompass severe or extreme physiological conditions and environmental factors that may present a danger to the health and safety of a user, are wirelessly transmitted to other connected edge devices. Speech-to-text translators, in combination with language learning models (LLMs), can provide a hands-free interface to populate plural fields of electronic documents.

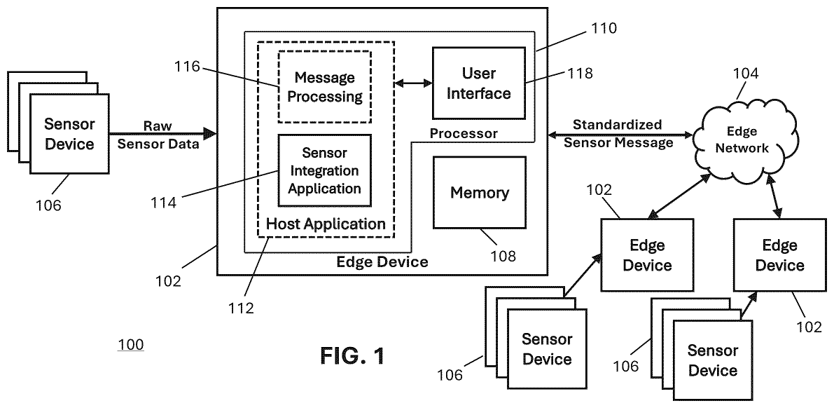

FIG. 1 illustrates a system for processing sensor data in accordance with an exemplary embodiment of the present disclosure. As shown in FIG. 1, the system 100 can include plural edge devices 102 that are connected to a secure edge network 104 that is without a centralized server. Each edge device 102 can be configured as a mobile computing device, such as a smart phone, tablet, handheld computing device, personal digital assistant, or other mobile computing device as desired, which is suitable for communicating sensor data on an edge network. The edge devices 102 can be connected to one or more sensors 106 associated with a user. The sensors 106 can include wearable sensors that can be worn, mounted, or attached to a user's body (e.g., on-body) or clothing, such as sensors configured to obtain physiological data from a user and/or environmental data from the user's surroundings. The edge device 104 can be include memory 108 and a processor 110. The memory 108 can be non-volatile storage device configured to store programming code for executing at least one application module for processing sensor data. The processor 110 can be configured access and execute the programming code stored in memory 108. Upon execution, the programming code causing the processor 110 to perform the operations of at least one application module and other operations for homogenizing or streamlining inconsistencies in the data generated by the sensors 106.

As shown in FIG. 1, the processor 110 can be configured to generate the at least one application module which can include a host application 112. The host application 112 can include a sensor integration application 114, a message processing module 116, and a user interface 118, which provide a hardware agnostic sensor platform that can integrate any sensor worn by a user, regardless of vendor, and aggregate the data of plural user sensors for communication between other edge devices 102 in the edge network 104.

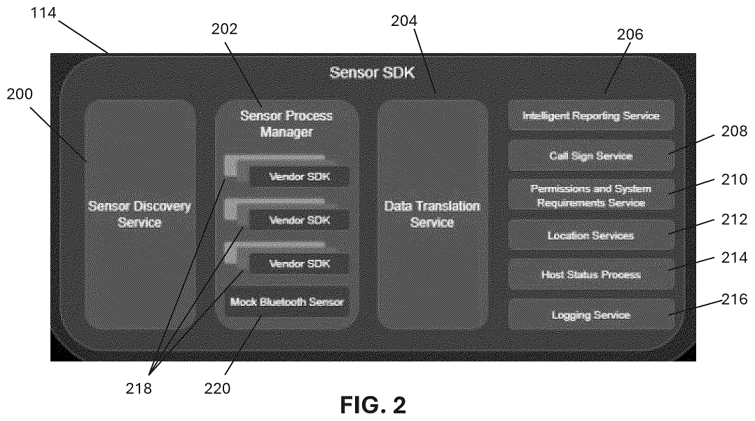

FIG. 2 illustrates a sensor integration application in accordance with an exemplary embodiment of the present disclosure. According to an exemplary embodiment, the sensor integration application 114 can include plural modules such as a sensor discovery service module 200, a sensor process manager module 202, a data translation service module 204, an intelligent reporting service module 206, a call sign service module 208, a permissions and system requirements service module 210, a location services module 212, a host status process module 214, and a logging services module 216. The processor 110 can be configured to execute the one or more operations of the sensor integration application as described below.

The sensor discovery service module 102 can configure the processor 110 to discover, by one or more communication protocols (Bluetooth, IP protocol), one or more sensors 106 proximate to the edge device 102. For example, the user can interact with the sensor device 106 to place the sensor device 106 in a discovery mode so that its presence can be detected by the user's edge device 102. The sensor device 106 can remain in a discoverable state for a limited time or until paired with the edge device 102. According to an exemplary embodiment, the sensor discovery service module 102 can be configured through the user interface (UI) 118 to periodically search for proximate sensors. As will be discussed in further detail, the user interface 118 can display one or more detected sensors for selection by the user. Once the sensor device 106 is paired and/or connected to the edge device 102, the processor 110 by executing the sensor process manager module 202, can connect the one or more discovered sensor devices (e.g., client devices) 106 to one of plural client interfaces 218 for receiving raw sensor data. Each client interface 218 can execute a sensor polling and data acquisition process that is isolated from processes executed by all other client interfaces. For example, according to an exemplary embodiment, each client interface 218 can be a child class that includes or inherits the attributes of an associated provider interface or parent class. A provider interface can include a set of instructions provided by a vendor or third party which defines an interaction between a sensor and an edge device 102. The sensor process manager module 202 governs the lifecycle for the client process run by each client interface 218 and brokers communication between each client process and its corresponding parent process run by the provider interface. As a result, the processor 110 can be connected to receive the sensor data from known or available commercial sensor device, based on a child class for the vendor or provider interface being instantiated within the sensor discovery module 114. The sensor process management module 202 can also include a Mock Bluetooth Sensor module 220, which allows for testing and simulating third-party sensors without vendor-specific or provider-specific hardware.

The data translation service module 204 can convert the received sensor data from each sensor 106 to a standardized format, wherein at least two of the sensors have different client interfaces 218. The data translation service 204 configures the processor 110 to receive the raw sensor data received in a client-specific reporting format of each client interface 202 and convert the output of each client interface 202 into a standardized format.

According to an exemplary embodiment, data translation service 204 can configure the processor 110 to translate the raw sensor data received from each client interface 218 into an extensible markup language (XML) message format and associated communications protocol so that the sensor data can be routed to other devices on the edge network 104. For example, the host application 112 can be configured to transmit messages using a Cursor-on-Target (CoT) message router. The raw sensor data can be translated into a CoT message format as follows:

```
<?xml version=“1.0”?>
  <event version=“1.0” uid=“trigger.notification” type=“a-f-G-U-C” time=“2023-12-14T19:04:38.000Z”
start=“2023-12-14T19:04:38.000Z” stale=“2023-12-14T19:06:38.000Z” how=“m-g”>
    <point lat=“0.0” lon=“0.0” hae=“9999999.0” ce=“9999999.0” le=“9999999.0”/>
    <detail>
      <device>
        <device_name>Polar H10 BBBD6729</device_name>
        <callsign>H10</callsign>
        <title>Heart Rate</title>
        <value>79</value>
        <level>danger</level>
      </device>
    </detail>
</event>
```

Table I provides a description of the parameters included in the CoT message.

TABLE I

| ELEMENT | ATTRIBUTE | DESCRIPTION |
|---|---|---|
| Event | version | Schema version of this event instance |
| | type | Hierarchically organized hint about event type |
| | uid | Globally unique name for the information on |
| | | this event |
| | time | Timestamp when the event was generated |
| | start | Starting time when the event should be |
| | | considered valid |
| | stale | Ending time when the event should no longer |
| | | be considered valid |
| | how | Gives a hint about how the coordinates were |
| | | generated |
| Point | lat | Latitude referred to the WGS-84 ellipsoid in |
| | | degrees |
| | lon | Longitude referred to the WGS-84 in degrees |
| | hae | Height above the WGS-84 ellipsoid in meters |
| | ce | Circular 1-sigma or a circular area about the |
| | | point in meters |
| | le | Linear 1-sigma error or an altitude range |
| | | about the point in meters |
| Detail | device_name | Descriptive name for the wearable |
| | callsign | Succinct callsign for the wearable |
| | title | Descriptive title for the trigger |
| | value | Value associated with the trigger |
| | level | Hazard level associated with the trigger |

The processor 110 can route the CoT messages according to a rule-based protocol and on a one-to-one or one-to-many routing capability. The message processing module 116 of the host application 112 can be configured for CoT message routing based on a subscription that contains the routing rules and other specified information, such as a destination address. The rules are broken into two types: a spatial-temporal bounds test and a regular expression test. Spatial-temporal bounds refer to a CoT message location, or “point.” A matching message would have its latitude, longitude, and height within the bounds of the subscriptions test. Regular expressions are more varied tests that can be specially tailored to check any CoT attribute. The attributes listed under the “Event” element in Table I are analyzed under the regular expression test, and the attributes associated with the “Point” element are analyzed under the spatial-temporal bounds test. The subscription tests can be performed to determine whether the information generated by a sensor matches parameters designated by the by the mission, environment, or operation.

The attributes associated with the “Detail” element are those which can be defined by the user. According to an exemplary embodiment, the user can interact with the user interface (UI) 118 and specify permissions and parameters relevant to the receipt and transmission of sensor data relevant to the user. The UI 118 can include a combination of hardware and software elements which provide for the display and/or output of various user prompts, and the ingestion and/or input of user data via the display, microphone, or other input device in response to the user prompts. For example, the UI 118 can provide controls for initiating the discovery of sensor devices 106 associated with the user. Moreover, the UI 118 can be configured to display vital information such as connected or paired sensors, notifications, and other details to the user.

According to an exemplary embodiment, the UI 118 can provide a mechanism that allows a user to assign a callsign to a paired sensor device. Once a sensor device 106 is connected, the UI 118 can allow the user to specify rules for triggering notifications. According to an exemplary embodiment, the rules can be established by specifying a name, a sensor, and at least one condition and endpoint. The endpoint is a location to which a trigger notification is sent, such as a storage location or destination address (e.g., an IP address). The UI 118 can allow a user to set up teams of other users within the same mission or operation. Because each user on the team possesses an edge device, the team setup provides for the trigger notifications for one user on the team to be sent to one or more other specified team members so that physiological condition of each team member can be monitored in real-time during a mission, operation, or exercise.

According to another exemplary embodiment, the UI 118 can provide a mechanism for making entries to electronic documents relevant to the mission or operation. The UI 118 can include a text or voice interface for populating one or more fields of an electronic document. The information for entry into an electronic document can also be obtained by using a camera device of the edge device 102 to scan a bar code, QR code, or RFID tag, or other suitable scannable encoded image as desired. In one example, the electronic document can include a Tactical Combat Casualty Care (TCCC) card. The TCCC card can be used by medical personnel (e.g., medic) involved in the mission or operation to provide lifesaving care to an injured team member, limit the risk of taking further casualties, and enable the team and/or unit to achieve mission success. The TCCC card can include basic information concerning the team and/or unit and demographic information on the medic. When the raw sensor data, which can contain the biometric, environmental, medical, and/or physiological data of a user, is received from the one or more sensors 106 associated with a user, the UI 118 can be configured to process the data through image and/or speech recognition, parse the data into chunks or segments, and automatically populate the TCCC with the user's biometric data. The TCCC can be accessed and/or stored in a remote storage location that is accessible by team and/or unit involved in the mission or operation. Once, the sensor data has been standardized, the processor 110 can communicate the standardized sensor data to a remote edge device at a predetermined transmission interval, which can be a recurring time period that is configured by a user at a respective edge device, or by a user at the remote edge device (i.e., host edge device). The callsign assigned to each sensor 106 through the UI 118 can be performed by the processor 110 using the callsign service module 208. This association persists in nonvolatile memory, so the information gets remembered across active software sessions and hardware reboots. The intelligent reporting service module 206 can send three pieces of information to the host application 112. For example, the intelligent reporting service module 206 can extract information from the converted sensor data of each sensor device 106, the extracted information including at least one of a currently polled profile of all sensor metrics of each sensor device 106, a previously polled profile of all sensor metrics of each sensor device 106, and a description of differences in the currently polled profile and the previously polled profile of the sensor metrics of each sensor device 106. The description also includes a list of additions, modifications, and removals. This level of granularity can ensure that the host application 112 can build user interfaces efficiently. The extracted information can be periodically transmitted to the host application using the reactive member variables hostMetrics and sensorProviderMetrics. The user can specify the transmission frequency through the UI 118 at startup. Abnormal and/or extreme events (e.g., trigger event) or acute variations in the sensor data can cause an out-of-phase transmissions to occur. For example, based on the type or severity of the abnormal and/or extreme event, the processor 110 can be configured to compute or determine the transmission interval at which out-of-phase transmission is to occur. The computation can be based on one or more factors/parameters including a health status of the user associated with the sensor device 108 and/or edge device 102, a type of object or activity detected by the sensor device 106, the type of sensor device 106 detecting the activity, a level of urgency assigned to or attached to a detected event or sensor device 106, an operating status or health status of the sensor device 106, an operating status or health status of the edge device 102 and/or processor 110 associated with the sensor device 106, a degradation in operating status, or health status, or a severity of the detected threat to communication with the host device, and/or any other suitable factors/parameters for computing a transmission interval as desired.

The permissions and requirements service module 210 keeps track of the services and permissions for running the various processes (e.g., BLE stack, IP stack, etc.) for the host application 112. Because the requirements for applications executed by the processor 110 can be specific to the configuration of the sensor integration application 114, the processor 110, by the permissions and requirements service module 210 is configured to determine the requirements at runtime and check the requirements before initialization. As a result, the processor 110 can ensure all necessary services and permissions are satisfied in advance of process execution. According to an exemplary embodiment, when services and permissions are not met, the permissions and requirements service module 210 can perform one or more operations for resolving the unmet conditions. For example, the permissions and requirements service module 210 can generate a user prompt on the UI 118 requesting that a precise or approximate location of the sensor be provided. In addition, UI 118 can be instructed to display user prompts related to: permitting the host application 112 to run in the background, permitting Internet access, an access network state, a change network state, a change WiFi state, an access coarse location (cell tower location), an access fine location (GPS location), a performing a Bluetooth scan, permitting Bluetooth connection, or other permissions or requirements specified by a vendor.

The location services module 212 contains logic to resolve all sensor locations in all circumstances. When the sensor device 106 reports a location, the location information is passed to the host application 112. However, when the location of the sensor device 106 is missing, the processor 110 by the location services module 212 can use one or more of several known schemes to determine the location. For example, the location service module 212 can be configured to use Global Position System (GPS), Bluetooth, other edge devices 102 on the network 104, and any other suitable location service as desired. Each location determination scheme is configurable at runtime. For example, one sensor device 106 connected to the edge device 102 can supplement the missing location using the location data provided by another sensor device 106 that is connected to the same edge device 102. According to another exemplary embodiment, the location reporting action can be deferred. These processes can ensure that the proper location is provided in the standardized sensor data.

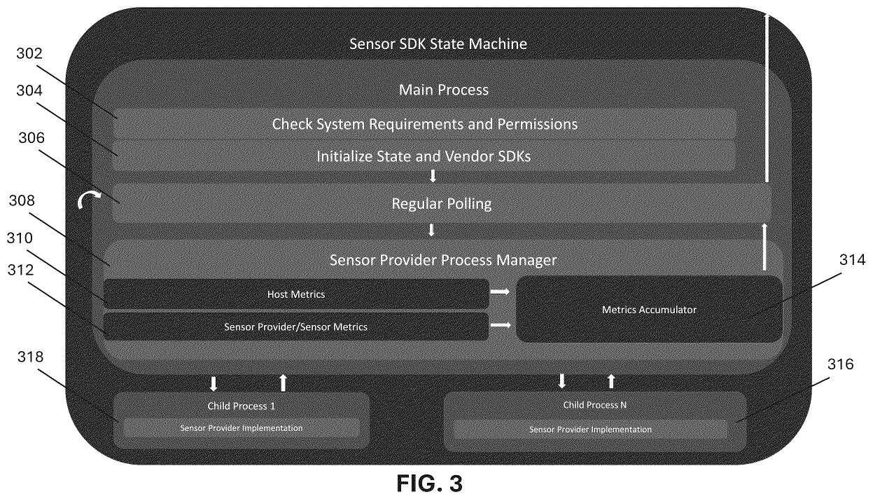

FIG. 3 illustrates a state machine performed by the sensor integration application in accordance with an exemplary embodiment of the present disclosure. As shown in FIG. 3, upon startup, the user is required to provide specified permissions and accessibility in order to access the features of the invention (SM 302). Upon start up, the host application will initiate the UI 118, which will prompt the user to enter the specified credentials for authorizing use and access. Once the user's credentials are verified, the sensor integration application 114 initializes the state of the paired sensor device(s) 106 and initializes the client interface 218 of each sensor device 106 (SM 304). After initializing the sensor devices 106 and the client interface 218, the processor 102 polls the sensor devices 106 via the sensor process manager module 202 at regular intervals (SM 306). The sensor process manager module 202 obtains basic metrics about the host (i.e., edge) device (310), such as, identifying whether the edge device 102 has GPS or Wi-Fi enabled. In addition, the sensor process manager module 202 obtains metrics on the sensor provider and the sensor 106 (312). These metrics can be obtained through the client interface and/or child processes 316, 318 executed by the sensor integration application 114. For example, the metrics can indicate when client interfaces 316, 318 start successfully and identify which vendors are supported. The sensor process manager module accumulates 202 accumulates the host metrics 310 and the sensor metrics 312 in a buffer. At each polling interval (SM 306), the accumulated metrics are output from the buffer and provided to the logging service module 216. The metrics can be stored in the logging service module 216 for diagnostics. The logging service module 216 manages runtime logs and reports them to the edge device via the host application 112. The logging service module 216 is configured to have three buckets of log statements, and each is configurable programmatically. The first bucket, BasicControlFlow, logs the information and commands reached during execution. These logs can help determine where the control flow of a command stops working. The second bucket, Errors, reports when an unexpected fault occurs. The third bucket, SensorProvider, when active, notifies the host application 112 of all vendor-specific client interfaces 218 and their internal logic.

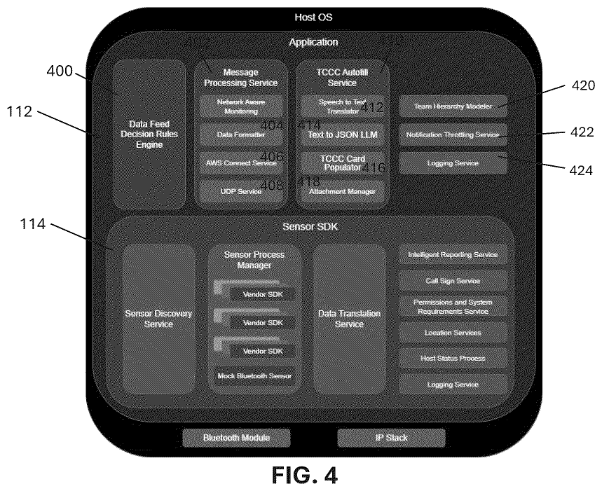

FIG. 4 illustrates a block diagram of a host application with the integrated sensor integration application in accordance with an exemplary embodiment of the present disclosure.

According to an exemplary embodiment, the sensor integration application 114 can be a process that the processor 110 executes within the host application 112. As shown in FIG. 4, the host application 112 includes a Data Feed Decision Rules Engine 400 that receives data from the sensor integration application 114, the rules engine 400 is configured with logic to set up, process, and report triggers defined by the user. The Message Processing Service module 402 is configured to process messages so that they are reliably communicated to their intended destination. The destination can be set in the UI 118, as already discussed. The Message Processing Service module 402 can provide in-order transmission using a first-in-first-out (FIFO) queue. Once a message is added to the queue, it can be immediately transferred to storage of the edge device 102 to ensure no messages are lost or forgotten if an error occurs. Using the queue, the processor 110 consumes and transmits each message from the device storage via IP across the edge network 104. Before a message gets sent, the Message Processing Service module 402 includes a data formatting module 404 to ensure that data is arranged in the proper standardized format, such as CoT. Only after successful transmission is the message erased from storage. The processor 110 executes the message processing operations continuously and/or at predetermined intervals. If the process or the device restarts, the processor 110 automatically resumes processing the queued messages stored at the time the processed terminated. The Message Processing Service module can include a Cloud Connect Service 406 for transmitting the message for storage on a cloud server. The UDP Service module 408 can be used to transmit trigger notifications for output to the UI 118.

The host application 112 can also include an electronic document autofill service 410. As already discussed, the autofill service 410 can be implemented using a trained neural network, which can be configured with a speech to text translator 412 for converting user's speech to text for populating the electronic document. The text can be input to a language learning model (LLM) 414 for parsing the speech into chunks, such as individual terms or phrases. Once the text is parsed, the Populator module 416 can be used to populate the electronic document, and the attachment manager module 418 can be configured to identify additional documentation to associate with and/or attached to the electronic document. The host application 112 uses the Team Hierarchy Modeler module 420 to determine where to send notifications. The destination for notifications can be set up by the user in the UI 118 through a team specification. The Notification r Service 422 can be used by the host application 112 to adjust the interval and/or timing of data and/or notification transmissions. The Throttler Service 422 can analyze the traffic on the edge network 104 and adjust the transmission of data based on results of the analysis. The Logging Service Module 424 is configured to receive aggregated metric information from the sensor integration application 114 and store the information for diagnostic purposes.

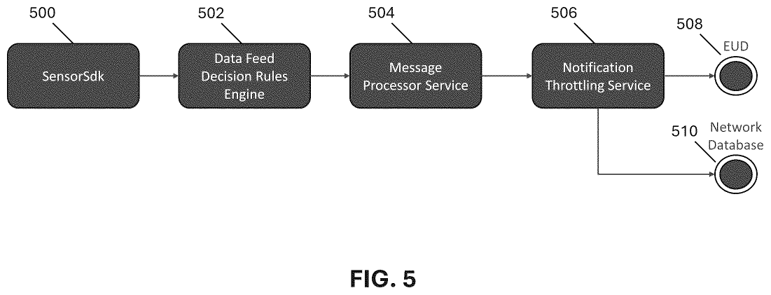

FIG. 5 illustrates a data flow for throttling notification messages in accordance with an exemplary embodiment of the present disclosure. As shown in FIG. 5, as already discussed, the user can interact with the UI 118 to configure the trigger rules and associated actions (S500). The Data Feed Decision Rules Engine module manages these rules (S502). In parallel, the sensor integration 114 module continuously streams new sensor data as it arrives from the one or more sensors 106. As a result, through the host application 112, the processor 110 can generate several notifications that can overwhelm the edge network creating traffic congestion and delays in messages being received at the destination edge device (S504). For this reason, the host application 112 is configured with a notification throttling service 422 that monitors traffic and can throttle the transmission of messages based on the monitoring results (S506). For example, the host application can be configured to throttle messages when a threshold of message traffic has been met or exceeded. According to an exemplary embodiment, if the network is unavailable or unreliable the notification throttling service 422 will prevent messages from being sent. In addition, a next message in the queue can be transmitted only after the immediately preceding message is successfully transmitted and received at the destination. If a message is not transmitted successfully in one instance, the notification throttling service 422 will retry sending the message until successful transmission is achieved. As a result, the system and/or each edge device 102 can ensure that the network 104 does not become overloaded. According to another exemplary embodiment, the edge network 104 can be configured according to a user datagram protocol (UDP). Under this configuration, the notification throttling service 422 can send messages in a bulk transmission. After transmission, the edge device 102 can enter a cool down period where no messages are transmitted. The transmission-cool down cycle can also prevent overloading the network 104. The notification throttling service 422 can send the messages to one or more user edge devices and/or to a network database based on the destination specifications set by the user (S508, S510).

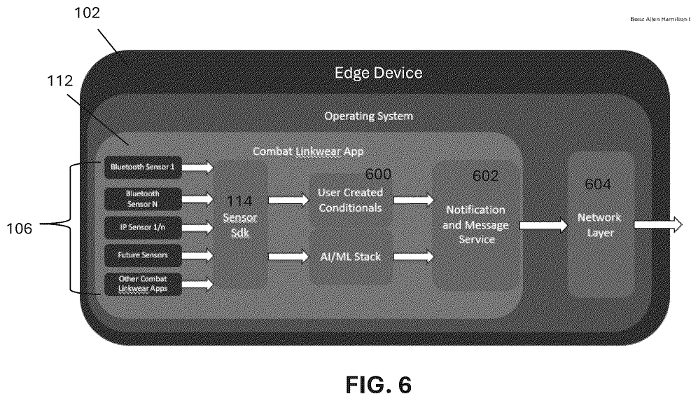

FIG. 6 illustrates data flow in an edge device of FIG. 1 in accordance with an exemplary embodiment of the present disclosure.

As shown in FIG. 6, the edge device 102 can run the host application 112 on its resident operating system (OS). For example, the edge device can be smart device having a processor 110 running the Android operating system, iOS operating system, or any other suitable OS as desired. The processor 110 executes a host application includes a software integration application module 114 configured to integrate all third-party vendor wearables and presents their data to the application level 600. The user can interact with the host application 112 through the UI 118, which allows the user to generate conditionals for generating triggers or notifications. The sensor data can be further processed through an AI/ML stack for populating electronic documents, such as a TCCC card. This level is also responsible for monitoring the real-time data provided by the Sensor SDK. If the data produces a trigger, a notification gets sent leveraging the OS network stack. The notification and message service 602 can process and format the sensor data for communication to the network layer 604 for transmission to other edge devices or to a database for storage. For example, each notification, sent using UDP/IP, traverses the edge network in a standardized format such as the Cursor-on-Target (CoT) format.

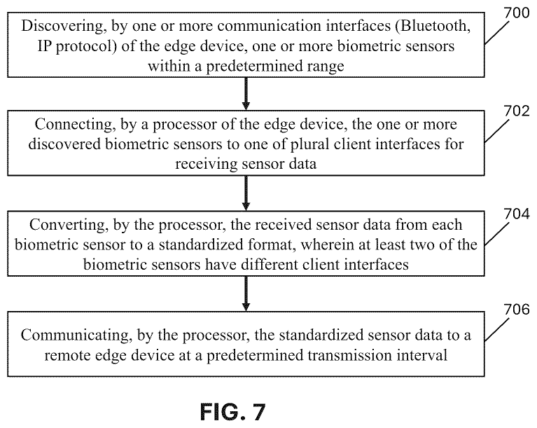

FIG. 7 illustrates a method for processing sensor data in accordance with an exemplary embodiment of the present disclosure.

As shown in FIG. 7, the edge device 102 can include a processor 110 that is configured to execute programming code for processing sensor data and generate at least one application module. The at least one application module causes the processor 110 to execute several operations which include discovering, by one or more communication interfaces of the edge device 102, one or more sensors 106 within a predetermined range (S700). The processor 110 can connect or pair with the one or more sensors using any one of plural available communication protocols. For example, the processor 110 can connect to the sensor devices 106 using Bluetooth Low Energy (BLE) protocol, IP protocol, Ethernet protocol, or any other suitable wireless or wired protocol as desired. When a discoverable sensor 106 is found, the processor 110 performs the step of connecting the one or more discovered sensors 106 to one of plural client interfaces 218 for receiving sensor data (S702). The client interfaces 218 are child processes of a related vendor processes, where the child process is generated by instantiating the attributes of the vendor process associated with a specified sensor 106 in the sensor integration application 114. The edge device 102 receives the sensor data from each paired sensor 106 through the client interfaces 218, and, by the processor 110, converts the sensor data received from each sensor to a standardized format (S704), wherein at least two of the sensors have different client interfaces 218. The processor 110 communicates the standardized sensor data to a remote edge device 102 at a predetermined transmission interval (S706). Through these steps, the processor 110 can perform hardware agnostic sensor device 106 integration, such that any sensor can be paired with the edge device and the sensor data communicated to other devices in an edge network in a consistent format.

According to an exemplary embodiment of the present disclosure, features of the host application can be implemented using one or more trained neural networks. For example, a neural network can be used to interpret sensor data and generate notifications about the user and the user's surroundings. The notifications can include information related to extreme physiological conditions and pressing environmental factors and can be wirelessly transmitted to other edge devices connected to the network. According to another example, a trained neural network, such as a language learning model (LLM) can be used as a speech-to-text translator to provide a hands-free interface to populate electronic documents, such as TCCC cards as already discussed. The trained neural networks can be configured to have deep learning (DL) architectures. Neural networks can include plural nodes that represent individual computational units. Each node has one or more biased input/output connections that function as transfer or activation functions for combining the inputs and outputs in a specified manner. The neural network can include plural nodes, where each node has one or more inputs and outputs for processing the textual input. The neural network can be formed by an arrangement of the plural nodes into multiple layers, the scheme within which the nodes are connected determines the type and operation of the neural network. For example, the neural network can include an input layer, multiple hidden layers, and an output layer. Each layer may perform a different or specified transformation on the respective inputs, using a different or specified mathematical calculation or function. Signals travel or are passed between the layers, from the input layer to the output layer via the middle or hidden layers and can traverse any layer and node(s) multiple times. The nodes can be connected in an array and each node can transmit a signal to a node in another layer of the neural network. The input/output connections between the nodes have a corresponding weight wₙⱼ and are combined according to the bias applied at each node. For example, the connections are activation or transfer functions which trigger the respective nodes and combine inputs according to mathematical equations or formulas according to the bias.

The exemplary system and methods of the present disclosure can be implemented using a number and arrangement of systems, hardware, and/or modules (e.g., software instructions). For example, the system can be a combination of two or more systems, hardware, and/or modules or may be implemented within a single system, hardware, and/or module. A single system, hardware, and/or module may be implemented as multiple, distributed systems, hardware, and/or modules. Additionally, or alternatively, a set of systems, a set of hardware, and/or a set of modules (e.g., one or more systems, one or more hardware devices, one or more modules) may perform one or more functions described as being performed by another set of systems, another set of hardware, or another set of modules.

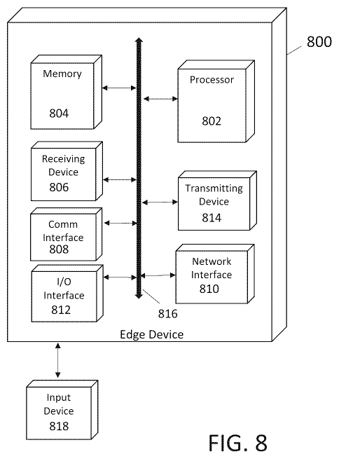

FIG. 8 illustrates a hardware configuration of an edge device in accordance with an exemplary embodiment of the present disclosure. As shown in FIG. 8, an exemplary edge device 800 can be configured for using training machine learning and/or artificial intelligence models (e.g., neural models, neural networks, and/or the like) for processing sensor data at the edge. The edge device 800 may include a processor (e.g., CPU and/or GPU) 802 and memory 804. The processor 802 may execute software instructions (e.g., program code) for processing sensor data to monitor physiological conditions of a user and an environment in which the user is located.

The processor 802 may be implemented in hardware, software, or a combination of hardware and software. For example, the 802 may include a common processor (e.g., a CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform a function.

The memory 804 may include random access memory (RAM), read-only memory (ROM), and/or another type of dynamic or static storage device (e.g., flash memory, magnetic memory, optical memory, etc.) that stores information and/or software instructions for use by the processor. Memory 804 may include a computer-readable medium and/or storage component. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory from another computer-readable medium or from another device via a communication interface with the computing device. When executed, software instructions stored in memory may cause the processor to perform one or more processes described herein. Embodiments described herein are not limited to any specific combination of hardware circuitry and software.

Any of the processors disclosed herein can include any integrated circuit or other electronic device (or collection of devices) capable of performing an operation on at least one instruction, which can include a Reduced Instruction Set Core (RISC) processor, a CISC microprocessor, a Microcontroller Unit (MCU), a CISC-based Central Processing Unit (CPU), a Digital Signal Processor (DSP), a Graphics Processing Unit (GPU), a Field Programmable Gate Array (FPGA), etc. The hardware of such devices may be integrated onto a single substrate (e.g., silicon “die”), or distributed among two or more substrates. Various functional aspects of the processor may be implemented solely as software or firmware associated with the processor.

The processor 802 can include one or more processing or operating modules. A processing or operating module can be a software or firmware operating module configured to implement any of the functions disclosed herein. The processing or operating module can be embodied as software and stored in memory the memory being operatively associated with the processor. A processing module can be embodied as a web application, a desktop application, a console application, etc.

The processor 802 can include or be associated with a computer or machine readable medium. The computer or machine readable medium can include memory. Any of the memory discussed herein can be computer readable memory configured to store data. The memory 804 can include a volatile or non-volatile, transitory, or non-transitory memory, and be embodied as an in-memory, an active memory, a cloud memory, etc. Examples of memory can include flash memory, Random Access Memory (RAM), Read Only Memory (ROM), Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

The memory 804 can be a non-transitory computer-readable medium. The term “computer-readable medium” (or “machine-readable medium”) as used herein is an extensible term that refers to any medium or any memory, which participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine readable medium can be configured to store one or more instructions thereon. The instructions can be in the form of algorithms, program logic, etc. that cause the processor to execute any of the functions disclosed herein.

Embodiments of the memory can include a processor module and other circuitry to allow for the transfer of data to and from the memory, which can include to and from other components of a communication system. This transfer can be via hardwired or wireless transmission. The communication system such as the communications interface 808 can include transceivers, which can be used in combination with switches, receivers, transmitters, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, or other non-Internet or wide area network communication scheme as desired.

Data stored in the exemplary computing device (e.g., in the memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can also be stored in the memory.

In an exemplary embodiment, the data can be configured in any type of suitable database configuration, such as a relational database, a structured query language (SQL) database, a distributed database, an object database, etc. Suitable configurations and storage types will be apparent to persons having skill in the relevant art.

The communications interface 808 can be configured to allow software and data to be transferred between the computing device and external devices. Exemplary communications interfaces can include a modem, a communications port, a PCMCIA slot and card, etc. Software and data transferred via the communications interface 808 can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable the computing device to implement the present methods as discussed herein. In particular, the computer programs stored on a non-transitory computer-readable medium, when executed, can enable hardware and/or the processor to implement the methods as discussed herein. Accordingly, such computer programs can represent controllers of the computing device.

An exemplary computing device or system for performing the operations disclosed herein may include at least one computing device and/or at least one component of computing device.

The edge system or device 800 may further include a receiver or receiving device 806, a network interface 810, an input/output (I/O) interface 812, a transmitting device 814, a communication infrastructure 816, and an input device 818. Memory, the receiver, and processor may be the same as or similar to the same named devices already disclosed herein.

The memory 804 can be configured for storing program code for at least one machine learning model. The memory can include one or more memory devices such as volatile or non-volatile memory. For example, the volatile memory can include random access memory. According to exemplary embodiments, the non-volatile memory can include one or more resident hardware components such as a hard disk drive and a removable storage drive (e.g., a floppy disk drive, a magnetic tape drive, an optical disk drive, a flash memory, or any other suitable device). The non-volatile memory can include an external memory device connected to communicate with the system via a mobile communication network. According to an exemplary embodiment, an external memory device can be used in place of any resident memory devices. Data stored in the system may be stored on any type of suitable computer readable media, such as optical storage (e.g., a compact disc, digital versatile disc, Blu-ray disc, etc.) or magnetic tape storage (e.g., a hard disk drive). The stored data can include network traffic data, log data, streaming events, and/or CDRs generated and/or accessed by the processor, and software or program code used by the processor for performing the tasks associated with the exemplary embodiments described herein. The data may be configured in any type of suitable database configuration, such as a relational database, a structured query language (SQL) database, a distributed database, an object database, etc. Suitable configurations and storage types will be apparent to persons having skill in the relevant art.

The receiving device 806 may be a combination of hardware and software components configured to receive data samples from the mobile network or database. According to exemplary embodiments, the receiving device 806 can include a hardware component such as an antenna, a communications port, a Personal Computer Memory Card International Association (PCMCIA) slot and card, 5G New Radio (NR) interface, or any other component or device suitable for use on a mobile communication network or Radio Access Network as desired. The receiving device 806 can be an input device for receiving signals and/or data samples formatted according to 3GPP protocols and/or standards. The receiving device 806 can be connected to other devices via a wired or wireless network or via a wired or wireless direct link or peer-to-peer connection without an intermediate device or access point. The hardware and software components of the receiving device can be configured to receive the data from the mobile network according to one or more communication protocols and data formats. For example, the receiving device 806 can be configured to communicate over a network including for example, a mesh network, a wireless network (e.g., Wi-Fi), a mobile communication network, a satellite network, fiber optic cable, coaxial cable, infrared, radio frequency (RF), another suitable communication medium as desired, or any combination thereof. During a receive operation, the receiving device 806 can be configured to identify parts of the received data via a header and parse the data signal and/or data packet into small frames (e.g., bytes, words) or segments for further processing at the processor.

The processor 802 can be configured for executing the program code stored in memory. Upon execution, the program code causes the processor to perform the functions at a node within a mesh network or edge computing device or system and executes program code for processing a natural language query and generating a response on the according to the exemplary embodiments described herein. The processor 802 can be a special purpose, or a general purpose computing device encoded with program code or software for performing the exemplary functions and/or features disclosed herein. According to exemplary embodiments of the present disclosure, the processor 802 can include a CPU and/or a GPU. The CPU can be connected to the communications infrastructure 816 including a bus, message queue, or network, multi-core message-passing scheme, for communicating with other components of the computing system, such as the memory 804, input device 818, the communications interface 816, and the I/O interface 814. The CPU can include one or more processors such as a microprocessor, microcomputer, programmable logic unit or any other suitable hardware computing devices as desired.

According to exemplary embodiments described herein, the combination of the memory and the processor can store and/or execute computer program code for performing the specialized functions described herein. The program code can be stored on a non-transitory computer readable medium, such as the memory devices for the computing device, which may be memory semiconductors (e.g., DRAMs, etc.) or other tangible and non-transitory means for providing software to the computing device. For example, via any known or suitable service or platform, the program code can be deployed (e.g., streamed and/or downloaded) remotely from other computing devices through a communication channel or link. In another example, the computer programs (e.g., computer control logic) or software may be stored in memory resident on/in the computing system or device. The computer programs or software may be stored in a computer program product or non-transitory computer readable medium and loaded into the computing device using any one or combination of a removable storage drive, an interface for internal or external communication, and a hard disk drive, where applicable. The computer programs or software, when executed, may enable the computing device to implement the present methods and exemplary embodiments discussed herein. Accordingly, such computer programs may represent controllers of the computing device.

The I/O interface 812 can be configured to receive the signal from the processor and generate an output suitable for a peripheral device via a direct wired or wireless link. The I/O interface 812 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

The transmitting device 814 can be configured to receive data from the processor and assemble the data into a data signal and/or data packets according to the specified communication protocol and data format of a peripheral device or remote device to which the data is to be sent. The transmitting device 814 can include any one or more of hardware and software components for generating and communicating the data signal over the communications infrastructure and/or via a direct wired or wireless link to a peripheral or remote device. The transmitting device can be configured to transmit information according to one or more communication protocols and data formats as discussed in connection with the receiving device.

According to exemplary embodiments described herein, the memory and the device processor can store and/or execute computer program code for performing the specialized functions described herein. It should be understood that the program code can be stored on a non-transitory computer usable medium, such as the memory devices for the system (e.g., computing device), which may be memory semiconductors (e.g., DRAMs, etc.) or other tangible non-transitory means for providing software to the system. The computer programs (e.g., computer control logic) or software may be stored in memory devices (e.g., device memory) resident on/in the system. The computer programs may also be received from external storage devices and/or network storage locations via a communications interface. Such computer programs, when executed, may enable the system to implement the present methods and exemplary embodiments discussed herein. Accordingly, such computer programs may represent controllers of the system. Where the present disclosure is implemented using software, the software may be stored in a computer program product or non-transitory computer readable medium and loaded into the system using any one or combination of a removable storage drive, an interface for internal or external communication, and a hard disk drive, where applicable.

In the context of exemplary embodiments of the present disclosure, a processor can include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processors (e.g., by a compiling module or engine) prior to execution. For example, the program code may be source code written in a programming language that is translated into a lower level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower level language suitable for controlling the system to perform the functions disclosed herein. It will be apparent to persons having skill in the relevant art that such processes result in the system being a specially configured computing device uniquely programmed to perform the functions of the exemplary embodiments described herein.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. An edge device, comprising:
memory configured for storing programming code for executing at least one application module for processing sensor data;
a processor configured to execute the programming code, the programming code causing the processor to:
discover, by one or more communication interfaces, one or more sensors;
connect the one or more discovered sensors to one of plural client interfaces for receiving sensor data;
convert the received sensor data of each sensor to a standardized format, wherein at least two of the sensors have different client interfaces; and
communicate the standardized sensor data to a remote edge device at a predetermined transmission interval.

2. The edge device according to claim 1, the one or more communication interfaces are configured to search for proximate sensors within a predetermined time interval.

3. The edge device according to claim 1, wherein each client interface among the plural client interfaces executes a sensor polling and data acquisition process that is isolated from processes executed by every other client interface among the plural client interfaces.

4. The edge device according to claim 3, wherein each client interface is configured to include the attributes of an associated vendor interface.

5. The edge device according to claim 4, wherein the processor is configured to manage communication between each client interface and the associated vendor interface.

6. The edge device according to claim 1, wherein to convert the sensor data, the processor is configured to translate a client-specific reporting format of each client interface into the standardized format.

7. The edge device according to claim 6, wherein the processor is configured to extract information from the converted sensor data of each sensor, the extracted information including at least one of a currently polled profile of one or more sensor metrics of each sensor, a previously polled profile of one or more sensor metrics of each sensor, and a description of differences in the currently polled profile and the previously polled profile of the sensor metrics of each sensor.

8. The edge device according to claim 7, wherein in extracting the description of differences from the converted sensor data, the processor is configured to generate a list of additions, modifications, and removals from the polled profile of the sensor metrics of each sensor.

9. The edge device according to claim 7, wherein the currently polled profile of the sensor metrics and a previously polled profile of the sensor metric are associated with one or more sensors of a common user.

10. The edge device according to claim 8, wherein the processor is configured to communicate the standardized sensor data to a host device at an irregular transmission interval when a trigger event is detected.

11. The edge device according to claim 10, wherein the trigger event can include a physiological event associated with the user.

12. The edge device according to claim 1, wherein the one or more sensors of a common user are associated with a call sign.

13. The edge device according to claim 2, wherein the processor is configured to perform automated location services for the one or more sensors based on the received sensor data, wherein a location of a first sensor of the one more sensors is determined based on a location of a second sensor of the one or more sensors.

14. The edge device according to claim 1, wherein the processor is configured to monitor data traffic at the edge and adjust the predetermined transmission interval based on a congestion level of the data traffic.

15. A method for processing sensor data at an edge device, the method comprising:
storing, by a memory device, programming code for executing at least one application module for processing sensor data;
executing, by the edge device, the programming code stored in the memory device, the programming code causing the edge device to be configured to perform operations including:
discovering, by one or more communication interfaces of the edge device, one or more sensors within a predetermined range;
connecting, by the edge device, the one or more discovered sensors to one of plural client interfaces for receiving sensor data;
converting, by the processor, the received sensor data of each sensor to a standardized format, wherein at least two of the sensors have different client interfaces; and
communicating, by the processor, the standardized sensor data to a remote edge device at a predetermined transmission interval.

16. The method of claim 15, wherein discovering the one or more sensors comprises searching for proximate sensors within a predetermined time interval.

17. The method of claim 15, comprising:
executing, by each client interface of the processor, a sensor polling and data acquisition process that is isolated from processes executed by other client interfaces of the processor, the isolation of the sensor polling and data acquisition process is based on attributes that each client interface inherits from an associated vendor interface.

18. The method of claim 17, comprising:
managing, by the processor, communication between each client interface and the associated vendor interface.

19. The method of claim 15, wherein converting the sensor data comprises translating a client-specific reporting format of at least one of the plural client interfaces into the standardized format.

20. The method of claim 19, comprising:
extracting information from the converted sensor data of each sensor, wherein the extracted information includes at least one of a currently polled profile of one or more sensor metrics of at least one of the one or more sensors, a previously polled profile of one or more sensor metrics of at least one of the one or more sensors, and a description of differences in the currently polled profile and the previously polled profile of the one or more sensor metrics of the at least one of the one or more sensors.

21. The method of claim 20, wherein extracting the description of differences from the converted sensor data, comprises:
generating a list of additions, modifications, and removals from the polled profile of the sensor metrics of the at least one of the one or more sensors.

22. The method of claim 21, comprising:
detecting occurrence of a trigger event of a user based on the extracted information.

23. The method of claim 22, comprising:
communicating the standardized sensor data to a host device at an irregular transmission interval when the trigger event is detected.

24. The method of claim 15, comprising:
performing automated location services for the one or more sensors based on the received sensor data, wherein a location of a first sensor of the one more sensors is determined based on a location of a second sensor of the one or more sensors.

25. The method of claim 15, comprising:
monitoring data traffic at the edge; and
adjusting the predetermined transmission interval based on a congestion level of the data traffic.

26. A non-transitory computer readable medium encoded with program code for processing sensor data, the computer readable medium, when placed in communicable contact with a device processor, causes the device processor to be configured to:
discover, by one or more communication interfaces, one or more sensors;
connect the one or more discovered sensors to one of plural client interfaces for receiving sensor data;
convert the received sensor data of each sensor to a standardized format, wherein at least two of the sensors have different client interfaces; and
communicate the standardized sensor data to a remote edge device at a predetermined transmission interval.
